(19) United States
(12) Patent Application Publication
(10) Pub. No.: US 2009/0124173 A1
(43) Pub. Date: May 14, 2009

(54) COMPOSITIONS AND METHODS FOR RUTHENIUM AND TANTALUM BARRIER CMP

(75) Inventor: Shoutian Li, Naperville, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 11/937,804

(22) Filed: Nov. 9, 2007

(51) Int. Cl. B24B 29/02; C09C 1/68

(52) U.S. Cl. 451/37; 51/308; 51/309

(57) ABSTRACT

This invention provides a chemical-mechanical polishing composition comprising an abrasive, an aqueous carrier, an oxidizing agent having a standard reduction potential of greater than 0.7 V and less than 1.3 V relative to a standard hydrogen electrode, and optionally a source of borate anions, with the proviso that when the oxidizing agent comprises a peroxide other than perborate, perphosphate, or percarbonate, the chemical-mechanical polishing composition further comprises a source of borate anions, wherein the pH of the chemical-mechanical polishing composition is between about 7 and about 12. The invention also provides a method of polishing a substrate with the aforementioned chemical-mechanical polishing composition.

### BACKGROUND OF THE INVENTION

Compositions and methods for planarizing or polishing the surface of a substrate are well known in the art. Polishing compositions (also known as polishing slurries) typically contain an abrasive material in an aqueous solution and are applied to a surface by contacting the surface with a polishing pad saturated with the slurry composition. Typical abrasive materials include silicon dioxide, cerium oxide, aluminum oxide, zirconium oxide, and tin oxide. U.S. Pat. No. 5,527,423, for example, describes a method for chemically-mechanically polishing a metal layer by contacting the surface with a polishing slurry comprising high purity fine metal oxide particles in an aqueous medium. Alternatively, the abrasive material may be incorporated into the polishing pad. U.S. Pat. No. 5,489,233 discloses the use of polishing pads having a surface texture or pattern, and U.S. Pat. No. 5,958,794 discloses a fixed abrasive polishing pad.

Conventional polishing compositions and polishing methods typically are not entirely satisfactory at planarizing semiconductor wafers. In particular, polishing compositions and polishing pads can exhibit less than desirable polishing rates and can result in poor surface quality of semiconductor wafers. Because the performance of a semiconductor wafer is directly associated with the planarity of its surface, it is crucial to use a polishing composition and method that results in a high polishing efficiency, uniformity, and removal rate and leaves a high quality polish with minimal surface defects.

The difficulty in creating an effective polishing composition and method for semiconductor wafers stems from the complexity of the semiconductor wafer. Semiconductor wafers typically are composed of a substrate on which a plurality of transistors has been formed. Integrated circuits are chemically and physically connected into a substrate by patterning regions in the substrate and layers on the substrate. To produce an operable semiconductor wafer and to maximize the yield, performance, and reliability of the wafer, it is desirable to polish select surfaces of the wafer without adversely affecting underlying structures or topography. In fact, various problems in semiconductor fabrication can occur if the process steps are not performed on wafer surfaces that are adequately planarized.

Various metals and metal alloys have been used to form electrical connections between devices, including titanium, titanium nitride, aluminum-copper, aluminum-silicon, copper, tungsten, platinum, platinum-tungsten, platinum-tin, ruthenium, and combinations thereof. Noble metals, including ruthenium, tantalum, iridium, and platinum, will be increasingly used in the next generation of memory devices and metal gates. Noble metals present a particular challenge in that they are mechanically hard and chemically resistant, thereby making them difficult to remove efficiently through chemical-mechanical polishing. As the noble metals are often components of substrates comprising softer and more readily abradable materials, including copper, problems of selectivity in preferential polishing of the noble metals versus over-polishing of the copper and dielectric materials frequently arise.

Chemical-mechanical polishing compositions developed for polishing of substrates comprising ruthenium present an additional challenge. The polishing compositions typically include an oxidizing agent to convert ruthenium metal into either a soluble form or into a soft oxidized film that is removed by abrasion.

Polishing compositions that have been developed for ruthenium and other noble metals typically contain strong oxidizing agents, have a low pH, or both. Strong oxidizing agents that provide useful removal rates for ruthenium at low pH are capable of converting ruthenium into ruthenium tetraoxide which, although soluble in water, is a highly toxic gas that necessitates special precautions for its containment and abatement during chemical-mechanical polishing operations.

Moreover, copper oxidizes very rapidly in polishing compositions comprising such strong oxidizing agents. Because of the difference in the standard reduction potentials of ruthenium and copper, copper suffers from galvanic attack by ruthenium in the presence of conventional ruthenium polishing compositions. This galvanic attack leads to etching of copper lines and a resulting degradation of circuit performance. Further, the substantial difference in chemical reactivity of copper and ruthenium in conventional polishing compositions results in widely differing rates of removal in chemical-mechanical polishing of substrates containing both metals, which can result in the overpolishing of copper.

Polishing compositions that utilize abrasion to remove ruthenium rely on the strong, mechanical action of alpha-alumina particles to achieve ruthenium removal, but alpha-alumina particles will not efficiently remove the dielectric layer. Thus, a need remains for additional polishing compositions and methods.

### BRIEF SUMMARY OF THE INVENTION

The invention provides a chemical-mechanical polishing composition comprising (a) an abrasive, (b) an aqueous carrier, (c) an oxidizing agent having a standard reduction potential of greater than 0.7 V and less than 1.3 V relative to a standard hydrogen electrode, and (d) optionally a source of borate anions, wherein the pH of the chemical-mechanical polishing composition is between about 7 and about 12. When the oxidizing agent comprises a peroxide other than perborate, percarbonate, or perphosphate, the chemical-mechanical polishing composition further comprises a source of borate anions.

The invention further provides a method of polishing a substrate comprising (i) providing a substrate; (ii) providing a chemical-mechanical polishing composition comprising: (a) an abrasive, (b) an aqueous carrier, (c) an oxidizing agent having a standard reduction potential of greater than 0.7 V and less than 1.3 V relative to a standard hydrogen electrode, and (d) optionally a source of borate anions, with the proviso that when the oxidizing agent comprises a peroxide other than perborate, percarbonate, or perphosphate, the chemical-mechanical polishing composition further comprises a source of borate anions, and wherein the pH of the chemical-mechanical polishing composition is between about 7 and about 12; (iii) contacting the substrate with a polishing pad and the chemical-mechanical polishing composition; and (iv) moving the polishing pad and the chemical-mechanical polishing composition relative to the substrate to abrade at least a portion of the surface of the substrate to polish the substrate.

### BRIEF DESCRIPTION OF THE SEVERAL VIEWS OF THE DRAWING(S)

FIG. 1 is a graph of a plot of potential (V) according to the standard hydrogen electrode (SHE) scale versus pH for a ruthenium-water system at 25° C.

FIG. 2 is a graph of a plot of potential (V) according to the mercurous sulfate electrode (MSE) scale versus current (A/cm²) at pH 2.2, 7.0, and 9.5 for a CMP composition described in Example 1 comprising 1 wt. % treated alpha alumina and 0.25 wt. % iodine (I₂) stabilized by malonate (C₃H₂O₄) (1:3 molar ratio).

FIG. 3 is a graph of a plot of potential (V) according to the MSE scale versus current (A/cm²) at pH 2.2 and 7.0 for a CMP composition described in Example 1 comprising 1 wt. % treated alpha alumina and 0.25 wt. % sodium nitrite (NaNO₂).

FIG. 4 is a graph of a plot of potential (V) according to the MSE scale versus current (A/cm²) at pH 2.2, 3.6, 7.0, and 9.5 for a CMP composition described in Example 1 comprising 1 wt. % treated alpha alumina and 0.25 wt. % sodium perborate monohydrate (NaBO₃.H₂O).

FIG. 5 is a graph of a plot of potential (V) according to the MSE scale versus current (A/cm²) for three CMP compositions described in Example 6: Composition 6A, comprising 0.25 wt. % sodium perborate monohydrate (NaBO₃.H₂O), at pH 9.85 without any adjustment; Composition 6B, comprising 1 wt. % hydrogen peroxide and 0.25 wt. % potassium tetraborate tetrahydrate at pH 9.85 (adjusted with KOH); and Composition 6C, comprising 1 wt. % hydrogen peroxide and 0.5 wt. % potassium tetraborate tetrahydrate at pH 9.85 (adjusted with ammonia).

### DETAILED DESCRIPTION OF THE INVENTION

The invention provides a chemical-mechanical polishing (CMP) composition for polishing a substrate. The CMP composition comprises (a) an abrasive, (b) an aqueous carrier, (c) an oxidizing agent having a standard reduction potential of greater than 0.7 V and less than 1.3 V relative to a standard hydrogen electrode, and (d) optionally a source of borate anions, with the proviso that when the oxidizing agent comprises a peroxide other than perborate, percarbonate, or perphosphate, the CMP composition further comprises a source of borate anions, wherein the pH of the CMP composition is between about 7 and about 12.

The abrasive can be any suitable abrasive, many of which are well known in the art. The abrasive desirably comprises a metal oxide. The metal oxide can be any suitable form of metal oxide, e.g., fumed, precipitated, condensation-polymerized, or colloidal. Suitable metal oxides include metal oxides selected from the group consisting of alumina, silica, titania, ceria, zirconia, germania, magnesia, co-formed products thereof, and combinations thereof. Preferably, the metal oxide is silica or alumina. More preferably, the abrasive is silica. Useful forms of silica include but are not limited to fumed silica, precipitated silica, condensation-polymerized silica, and colloidal silica. Most preferably, the silica is colloidal silica. As utilized herein, the term “colloidal silica” refers to silica particles that can form colloidally stable dispersions in the CMP composition as described hereinafter. Generally, colloidal silica particles are discrete, substantially spherical silica particles having no internal surface area. Colloidal silica typically is produced by wet-chemistry processes, such as the acidification of an alkaline metal silicate-containing solution.

The abrasive can have any suitable particle size. Typically, the abrasive has an average particle size of about 1 μm or less (e.g., about 5 nm to about 1 μm). Preferably, the abrasive has an average particle size of about 500 nm or less (e.g., about 10 nm to about 500 nm). The size of a particle is the diameter of the particle or, for particles that are not spherical, the diameter of the smallest sphere that encompasses the particle.

The abrasive particles suitable for use in the invention can be treated or untreated. Possible treatments include hydrophobicizing treatments as well as treatments to alter the surface charge characteristics, e.g., cationic or anionic treatments. Accordingly, the abrasive particles suitable for use in the invention can comprise, can consist essentially of, or can consist of one or more metal oxides. For example, the abrasive can comprise silica, can consist essentially of silica, or can consist of silica (SiO₂). Preferably, the abrasive particles are untreated.

The abrasive can be present in the CMP composition in any suitable amount. For example, the abrasive can be present in the CMP composition in an amount of about 0.1 wt. % or more, e.g., about 0.2 wt. % or more, about 0.5 wt. % or more, or about 1 wt. % or more. Alternatively, or in addition, the abrasive can be present in the CMP composition in an amount of about 20 wt. % or less, e.g., about 15 wt. % or less, about 12 wt. % or less, about 10 wt. % or less, about 8 wt. % or less, about 5 wt. % or less, about 4 wt. % or less, or about 3 wt. % or less. Thus, the abrasive can be present in the CMP composition in an amount of about 0.1 wt. % to about 20 wt. %, e.g., about 0.1 wt. % to about 12 wt. %, or about 0.1 wt. % to about 4 wt. %.

The abrasive desirably is suspended in the CMP composition, more specifically in the aqueous carrier of the CMP composition. When the abrasive is suspended in the CMP composition, the abrasive preferably is colloidally stable. The term “colloid” refers to the suspension of abrasive particles in the aqueous carrier. “Colloidal stability” refers to the maintenance of that suspension over time. In the context of this invention, an abrasive is considered colloidally stable in a CMP composition if, when the CMP composition is placed into a 100 mL graduated cylinder and allowed to stand without agitation for a time of 2 hours, the difference between the concentration of abrasive in the bottom 50 mL of the graduated cylinder ([B] in terms of g/mL) and the concentration of abrasive in the top 50 mL of the graduated cylinder ([T] in terms of g/mL) divided by the initial concentration of abrasive in the CMP composition ([C] in terms of g/mL) is less than or equal to 0.5 (i.e., {[B]-[T]}/[C]≦0.5). The value of [B]-[T]/[C] desirably is less than or equal to 0.3, and preferably is less than or equal to 0.1.

The aqueous carrier can be any suitable aqueous carrier. The aqueous carrier is used to facilitate the application of the abrasive (when suspended in the aqueous carrier), the oxidizing agent(s), and any other components dissolved or suspended therein to the surface of a suitable substrate to be polished (e.g., planarized). The aqueous carrier can be water alone (i.e., can consist of water), can consist essentially of water, can comprise water and a suitable water-miscible solvent, or can be an emulsion. Suitable water-miscible solvents include alcohols, such as methanol, ethanol, etc., and ethers, such as dioxane and tetrahydrofuran. Preferably, the aqueous carrier comprises, consists essentially of, or consists of water, more preferably deionized water.

The chemical-mechanical polishing composition further comprises an oxidizing agent. The oxidizing agent can be any suitable oxidizing agent. Ruthenium metal can be oxidized to +2, +3, +4, +6, +7, and +8 oxidation states (see, e.g., M. Pourbaix, Atlas of Electrochemical Equilibria in Aqueous Solutions, 343-349 (Pergamon Press 1966)). The common oxide forms are Ru₂O₃, i.e., Ru(OH)₃, RuO₂, and RuO₄, in which ruthenium is oxidized to the +3, +4, and +8 oxidation states, respectively. The oxidization of ruthenium to the +8 oxidation state, i.e., the formation of RuO₄, produces a toxic gas. As such, it is desirable to avoid oxidation of ruthenium to the +8 oxidation state during CMP applications. Strong oxidizing agents, e.g., potassium hydrogen peroxymonosulfate (OXONE™ oxidizing agent) and KBrO₃, which oxidize ruthenium to its high oxidation state, are therefore not preferred for use in CMP compositions. The oxidation of ruthenium to the +4 oxidation state, i.e., the formation of RuO₂, results in the formation of a protective layer on the surface of the ruthenium that can require a hard abrasive, e.g., alpha alumina, for removal. The oxidation of ruthenium to the +3 oxidation state, i.e., the formation of Ru(OH)₃, results in a layer that is not as protective. This layer does not require hard abrasives for removal, and can be removed, for example, by colloidal silica.

Accordingly, a CMP composition for polishing ruthenium desirably comprises an oxidizing agent that oxidizes ruthenium to its +3 or +4 oxidation state while avoiding the oxidation of ruthenium to its +8 oxidation state. The CMP composition also desirably modifies the protective nature of RuO₂ if ruthenium is oxidized to its +4 oxidation state.

Potential oxidizing agents can be characterized according to an electrochemical test (see Jian Zhang, Shoutian Li, & Phillip W. Carter, “Chemical Mechanical Polishing of Tantalum, Aqueous Interfacial Reactivity of Tantalum and Tantalum Oxide,” Journal of the Electrochemical Society, 154(2), H109-H114 (2007)). The oxidizing agent can have any suitable standard reduction potential relative to a standard hydrogen electrode. Desirably, moderate oxidizing agents appropriate for use in the CMP composition have an electrochemical potential that is slightly greater than that needed to oxidize ruthenium to its +3 oxidation state, i.e., the E⁰ value for R⁰→Ru⁺³, but slightly less than that required to oxidize ruthenium to its +8 oxidation state, i.e., the E⁰ value for Ru⁰→Ru⁺⁸.

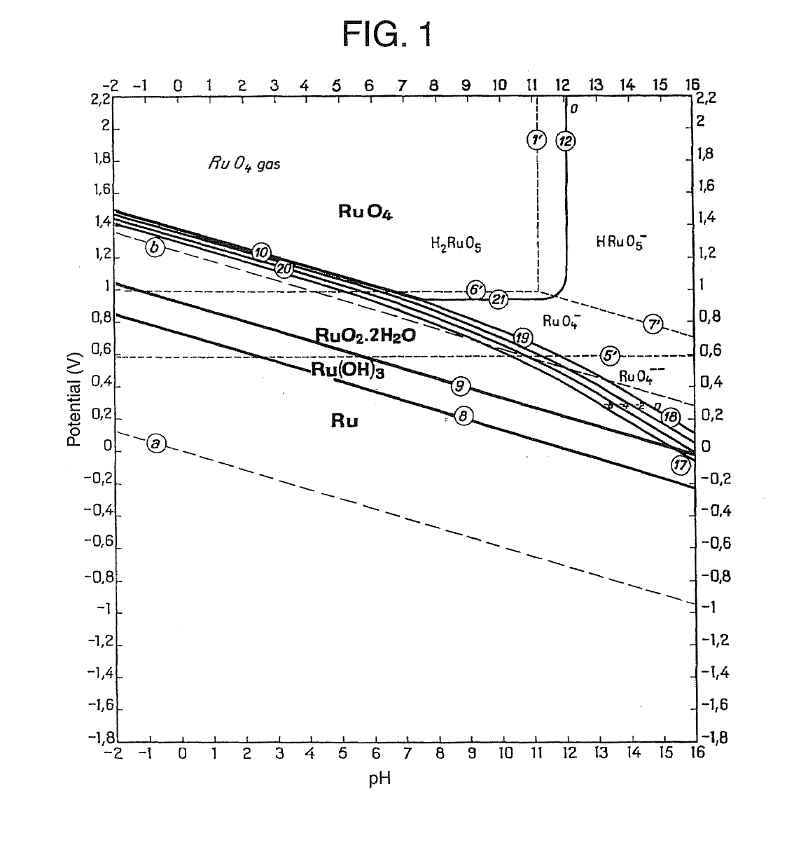

FIG. 1 is a graph that plots ruthenium potential versus pH according to a standard hydrogen electrode (SHE). The following table summarizes the approximate potential (V) required to form particular ruthenium compounds at various pH values according to FIG. 1:

| Ruthenium | Ruthenium | Approximate Potential | | | | | | |
|---|---|---|---|---|---|---|---|---|
| Oxidation | Compound | (V) at Various pH Values | | | | | | |
| State | Formed | pH 0 | pH 7 | pH 8 | pH 9 | pH 10 | pH 11 | pH 12 |
| Ru⁺³ | Ru(OH)₃ | 0.7 | 0.3 | 0.2 | 0.1 | 0.05 | 0 | −0.1 |
| Ru⁺⁴ | RuO₂ | 0.9 | 0.5 | 0.4 | 0.3 | 0.25 | 0.2 | 0.1 |
| Ru⁺⁸ | RuO₄ | 1.3 | 0.8 | 0.7 | 0.65 | 0.6 | 0.55 | 0.5 |

The oxidizing agent can be any suitable oxidizing agent having a standard reduction potential, i.e., a reduction potential under standard conditions and at pH=0, that oxidizes ruthenium to its +3 or +4 oxidation state while avoiding the oxidation of ruthenium to its +8 oxidation state. For example, the oxidizing agent can have a standard reduction potential of greater than about 0.7 V relative to a standard hydrogen electrode, e.g., greater than about 0.75 V, greater than about 0.8 V, greater than about 0.9 V, greater than about 1 V, or greater than about 1.25 V. Alternatively, or in addition, the oxidizing agent can have a standard reduction potential of less than about 1.3 V relative to a standard hydrogen electrode, e.g., less than about 1.2 V, less than about 1 V, or less than about 0.9 V. Thus, the oxidizing agent can have a standard reduction potential of greater than about 0.7 V and less than about 1.3 V relative to a standard hydrogen electrode, e.g., greater than about 0.7 and less than about 0.8 V, greater than about 0.7 V and less than about 0.9 V, greater than about 0.8 V and less than about 0.9 V, greater than about 0.9 V and less than about 1.3 V, greater than about 0.9 V and less than about 1.1 V, or greater than about 1 V and less than about 1.3 V.

Desirably, the oxidizing agent substantially does not oxidize ruthenium to the +8 oxidation state. Further, as can be seen from FIG. 1 and the above table, ruthenium has a lower potential at higher pH values. Desirably, at these higher pH values, the ruthenium potential is closer to that of copper, thereby reducing the risk of galvanic incompatibility between ruthenium and copper.

Preferred oxidizing agents include, without limitation, oxidizing agents comprising perborate, percarbonate, perphosphate, peroxide, or combinations thereof. The perborate, percarbonate, perphosphate, and peroxide can be provided from any suitable source compound.

Suitable perborate compounds include, without limitation, potassium perborate and sodium perborate monohydrate. Suitable percarbonate compounds include, without limitation, sodium percarbonate. Suitable perphosphate compounds include, without limitation, potassium perphosphate.

Suitable peroxide compounds are compounds containing at least one peroxy group (—O—O—) and are selected from the group consisting of organic peroxides, inorganic peroxides, and mixtures thereof. Examples of compounds containing at least one peroxy group include, without limitation, hydrogen peroxide and its adducts such as urea hydrogen peroxide and percarbonates, organic peroxides such as benzoyl peroxide, peracetic acid, and di-tert-butyl peroxide, monopersulfates (SO₅²⁻), dipersulfates (S₂O₈²⁻), and sodium peroxide. Preferably, the peroxide is hydrogen peroxide.

The oxidizing agent can be present in the CMP composition in any suitable amount. For example, the oxidizing agent can be present in an amount of about 10 wt. % or less, e.g., about 8 wt. % or less, about 5 wt. % or less, about 3 wt. % or less, about 2 wt. % or less, or about 1 wt. % or less. Alternatively, or in addition, the oxidizing agent can be present in an amount of about 0.05 wt. % or more, e.g., about 0.07 wt. % or more, about 0.1 wt. % or more, about 0.25 wt. % or more, about 0.5 wt. % or more, or about 0.75 wt. % or more. Accordingly, the oxidizing agent can be present in an amount of about 0.05 wt. % to about 10 wt. %, e.g., from about 0.07 wt. % to about 8 wt. %, from about 0.1 wt. % to about 5 wt. %, from about 0.25 wt. % to about 3 wt. %, from about 0.5 wt. % to about 2 wt. %, or from about 0.75 wt. % to about 1 wt. %. Preferably, the oxidizing agent is present in the CMP composition in an amount between about 0.25 wt. % and about 1 wt. %.

The CMP composition optionally further comprises a source of borate anions. Accordingly, the oxidizing agent can be used alone or in combination with a source of borate anions. When the oxidizing agent comprises a peroxide other than perborate, percarbonate, or perphosphate, the CMP composition further comprises a source of borate anions. The source of borate anions can be any suitable borate compound(s), including, for example, an inorganic salt, a partial salt, or an acid comprising the borate anions. Preferred sources of borate anions include, without limitation, potassium tetraborate tetrahydrate and ammonium biborate tetrahydrate.

Without wishing to be bound by any particular theory, it is believed that the reaction of tetraborate, hydrogen peroxide, and hydroxide can proceed as follows:

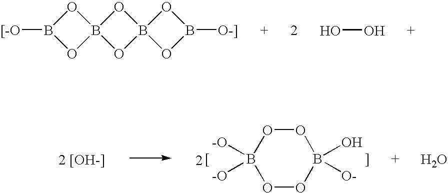

Accordingly, the combination of an oxidizing agent, e.g., hydrogen peroxide, a source of borate anions, e.g., potassium tetraborate, and a source of hydroxide, is chemically equal to perborate and can function similarly as an oxidizing agent in a CMP composition. Alternatively, or in addition, the hydrogen peroxide and the borate anions can function separately, i.e., the hydrogen peroxide can function as an oxidizing agent, oxidizing ruthenium to RuO₂, while the borate anions can react with the RuO₂ layer to disrupt its protective nature.

The source of borate anions can be present in the CMP composition in any suitable amount. For example, the source of borate anions can be present in an amount of about 10 wt. % or less, e.g., about 8 wt. % or less, about 5 wt. % or less, about 3 wt. % or less, about 2 wt. % or less, or about 1 wt. % or less. Alternatively, or in addition, the source of borate anions can be present in an amount of about 0.01 wt. % or more, e.g., about 0.03 wt. % or more, about 0.05 wt. % or more, about 0.1 wt. % or more, about 0.25 wt. % or more, about 0.5 wt. % or more, or about 0.75 wt. % or more. Accordingly, the source of borate anions can be present in an amount of about 0.01 wt. % to about 10 wt. %, e.g., from about 0.05 wt. % to about 8 wt. %, from about 0.1 wt. % to about 5 wt. %, from about 0.25 wt. % to about 3 wt. %, from about 0.5 wt. % to about 2 wt. %, or from about 0.75 wt. % to about 1 wt. %. Preferably, the source of borate anions is present in the CMP composition in an amount between about 0.1 wt. % and about 0.5 wt. %.

The CMP composition can have any suitable pH. The pH of CMP composition can be, for example, about 12 or less, e.g., about 11 or less, about 10 or less, or about 9 or less. Alternatively, or in addition, the pH of the CMP composition can be about 7 or more, e.g., about 8 or more, about 9 or more, about 10 or more, or about 11 or more. Desirably, the pH of the CMP composition is between about 7 and about 12, e.g., between about 7 and about 9, between about 9 and about 12, between about 9 and about 11, between about 10 and about 12, or between about 11 and about 12. At this pH range, as illustrated in FIG. 1, ruthenium has a lower potential, i.e., a potential that is closer to the potential of copper, compared to the potential of ruthenium at a lower pH, e.g., a pH of 2. Desirably, a relatively low ruthenium potential reduces the risk of galvanic incompatibility between ruthenium and copper, preventing the CMP composition from galvanically dissolving thin copper lines during ruthenium barrier CMP.

The pH of the CMP composition can be achieved and/or maintained by any suitable means. More specifically, the CMP composition can further comprise a pH adjustor. The pH adjustor can be any suitable pH-adjusting compound. For example, the pH adjustor can be nitric acid, potassium hydroxide, ammonium hydroxide, tetraalkylammonium hydroxide, or a combination thereof. The CMP composition can comprise any suitable amount of a pH adjustor, provided that a suitable amount is used to achieve and/or maintain the pH of the CMP composition within the ranges set forth herein.

The CMP composition optionally further comprises an ammonia derivative. Without wishing to be bound by any particular theory, it is believed that the ammonia derivative reduces the open-circuit potential of ruthenium, thereby reducing the risk of galvanic incompatibility between ruthenium and copper. More specifically, while the presence of an ammonia derivative does not significantly affect the open-circuit potential of copper, it can reduce the open-circuit potential of ruthenium by as much as about 0.3 V, e.g., by about 0.2 V, by about 0.1 V, or by about 0.05 V, relative to a standard hydrogen electrode.

The ammonia derivative can be any suitable ammonia derivative. Preferably, the ammonia derivative is selected from the group consisting of ammonium-containing compounds, hydroxylamines, methylamines, and combinations thereof. Suitable ammonium-containing compounds, include, for example, ammonium acetate. Suitable hydroxylamines include, for example, hydroxylamine, ethanolamine, and diethanolamine. Suitable methylamines include, for example, methylamine, dimethylamine, and trimethylamine. Most preferably, the ammonia derivative is ammonium acetate or hydroxylamine.

The ammonia derivative can be present in the CMP composition in any suitable amount. For example, the ammonia derivative can be present in an amount of about 2 wt. % or less, e.g., about 1.5 wt. % or less, about 1 wt. % or less, about 0.75 wt. % or less, or about 0.5 wt. % or less. Alternatively, or in addition, the ammonia derivative can be present in an amount of about 0.01 wt. % or more, e.g., about 0.02 wt. % or more, about 0.05 wt. % or more, about 0.07 wt. % or more, or about 0.1 wt. % or more. Accordingly, the ammonia derivative can be present in an amount of about 0.01 wt. % to about 2 wt. %, e.g., from about 0.02 wt. % to about 1.5 wt. %, from about 0.05 wt. % to about 1 wt. %, from about 0.07 wt. % to about 0.75 wt. %, or from about 0.1 wt. % to about 0.5 wt. %.

The CMP composition optionally further comprises a corrosion inhibitor. The corrosion inhibitor (i.e., a film-forming agent) can be any suitable corrosion inhibitor. Typically, the corrosion inhibitor is an organic compound containing a heteroatom-containing functional group. For example, the corrosion inhibitor is a heterocyclic organic compound with at least one 5- or 6-member heterocyclic ring as the active functional group, wherein the heterocyclic ring contains at least one nitrogen atom, for example, an azole compound. Preferably, the corrosion inhibitor is a triazole, more preferably, 1,2,4-triazole, 1,2,3-triazole, 6-tolyltriazole, or benzotriazole.

The CMP composition optionally further comprises a complexing agent or chelating agent. The complexing or chelating agent can be any suitable complexing or chelating agent that enhances the removal rate of the substrate layer being removed. Suitable chelating or complexing agents can include, for example, carbonyl compounds (e.g., acetylacetonates, and the like), simple carboxylates (e.g., acetates, aryl carboxylates, and the like), carboxylates containing one or more hydroxyl groups (e.g., glycolates, lactates, gluconates, gallic acid and salts thereof, and the like), di-, tri-, and poly-carboxylates (e.g., oxalates, phthalates, citrates, succinates, tartrates, malates, edentates (e.g., dipotassium EDTA), mixtures thereof, and the like), carboxylates containing one or more sulfonic and/or phosphonic groups, and the like. Suitable chelating or complexing agents also can include, for example, di-, tri-, or polyalcohols (e.g., ethylene glycol, pyrocatechol, pyrogallol, tannic acid, and the like) and amine-containing compounds (e.g., ammonia, amino acids, amino alcohols, di-, tri-, and polyamines, and the like). Preferably, the complexing agent is a carboxylate salt, more preferably an oxalate salt. The choice of chelating or complexing agent will depend on the type of substrate layer being removed in the course of polishing a substrate with the CMP composition.

The CMP composition optionally further comprises one or more other additives. The polishing composition can comprise a surfactant and/or Theological control agent, including viscosity enhancing agents and coagulants (e.g., polymeric rheological control agents, such as, for example, urethane polymers). Suitable surfactants include, for example, cationic surfactants, anionic surfactants, anionic polyelectrolytes, nonionic surfactants, amphoteric surfactants, fluorinated surfactants, mixtures thereof, and the like.

The CMP composition can be prepared by any suitable technique, many of which are known to those skilled in the art. The CMP composition can be prepared in a batch or continuous process. Generally, the CMP composition can be prepared by combining the components herein in any order. The term “component” as used herein includes individual ingredients (e.g., oxidizing agent, abrasive, etc.) as well as any combination of ingredients (e.g., oxidizing agent, source of borate anions, surfactants, etc.).

The invention further provides a chemical-mechanical polishing composition comprising (a) an abrasive, (b) an aqueous carrier, and (c) an oxidizing agent having a standard reduction potential of greater than 0.7 V and less than 1.3 V relative to a standard hydrogen electrode, wherein the oxidizing agent comprises perborate, and wherein the pH of the chemical-mechanical polishing composition is between about 7 and about 12.

The invention still further provides a chemical-mechanical polishing composition comprising (a) an abrasive, (b) an aqueous carrier, (c) an oxidizing agent having a standard reduction potential of greater than 0.7 V and less than 1.3 V relative to a standard hydrogen electrode, wherein the oxidizing agent comprises percarbonate, perphosphate, peroxide, or combinations thereof, and (d) a source of borate anions, and wherein the pH of the chemical-mechanical polishing composition is between about 7 and about 12.

The invention also provides a method of polishing a substrate with a polishing composition as described herein. The method of polishing a substrate comprises (i) providing a substrate, (ii) providing an aforementioned chemical-mechanical polishing composition, (iii) contacting the substrate with a polishing pad and the chemical-mechanical polishing composition, and (iv) moving the polishing pad and the chemical-mechanical polishing composition relative to the substrate to abrade at least a portion of the surface of the substrate to polish the substrate.

In accordance with the invention, a substrate can be planarized or polished with the CMP composition described herein by any suitable technique. The polishing method of the invention is particularly suited for use in conjunction with a CMP apparatus. Typically, the CMP apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing system of the invention and then abrading at least a portion of the surface of the substrate with the polishing system to polish the substrate.

Desirably, the CMP apparatus further comprises an in situ polishing endpoint detection system, many of which are known in the art. Techniques for inspecting and monitoring the polishing process by analyzing light or other radiation reflected from a surface of the workpiece are known in the art. Such methods are described, for example, in U.S. Pat. No. 5,196,353, U.S. Pat. No. 5,433,651, U.S. Pat. No. 5,609,511, U.S. Pat. No. 5,643,046, U.S. Pat. No. 5,658,183, U.S. Pat. No. 5,730,642, U.S. Pat. No. 5,838,447, U.S. Pat. No. 5,872,633, U.S. Pat. No. 5,893,796, U.S. Pat. No. 5,949,927, and U.S. Pat. No. 5,964,643. Desirably, the inspection or monitoring of the progress of the polishing process with respect to a workpiece being polished enables the determination of the polishing end-point, i.e., the determination of when to terminate the polishing process with respect to a particular workpiece.

### EXAMPLES

The following examples further illustrate the invention but, of course, should not be construed as in any way limiting its scope.

In each of the following examples, unless otherwise indicated, the electrochemical tests were carried out as follows. A PAR potentiostat 273A, Powersuit software, and a three-electrode cell assembly including a ruthenium working electrode, a mercury sulfate reference electrode (MSE), and a platinum mesh counter electrode, were used to conduct the electrochemical test. The standard potentiodynamic tests were performed with a rotating electrode (500 rpm) in the following sequence: (1) with electrode abrasion, the open-circuit potential was measured for 30 seconds, (2) the potential was then scanned with a scan rate of 10 mV/s in a potential range from −250 mV below the open-circuit potential to some anodic potential with recording of the current, (3) the open-circuit potential was measured again, with abrasion, as the abrasion ceased, and about 2 minutes after abrasion, and (4) a potentiodynamic scan was reapplied. Without wishing to be bound by any particular theory, it is believed that the electrochemical data, open-circuit potential, and current density with abrasion represent the chemical reactions during polishing. All electrode potentials were measured and referenced on the mercury-mercurous sulfate electrode (MSE) scale, which is +0.615 V versus the standard hydrogen electrode (SHE) scale.

### Example 1

This example demonstrates the effect of perborate on CMP compositions utilized for ruthenium polishing.

Chemical-mechanical polishing compositions were prepared with three different oxidizing agents (Polishing Compositions 1A-1C). Each composition was electrochemically tested to determine whether it was suitable for ruthenium polishing. The electrochemical test procedure was carried out as described above.

Each composition included 1 wt. % treated alpha-alumina as an abrasive and 0.25 wt. % of an oxidizing agent, as indicated in Table 1. Each oxidizing agent is a moderate oxidizing agent with an electrochemical potential that is slightly higher than that needed to form RuO₂ (i.e., the E⁰ value for Ru⁰→Ru⁺⁴).

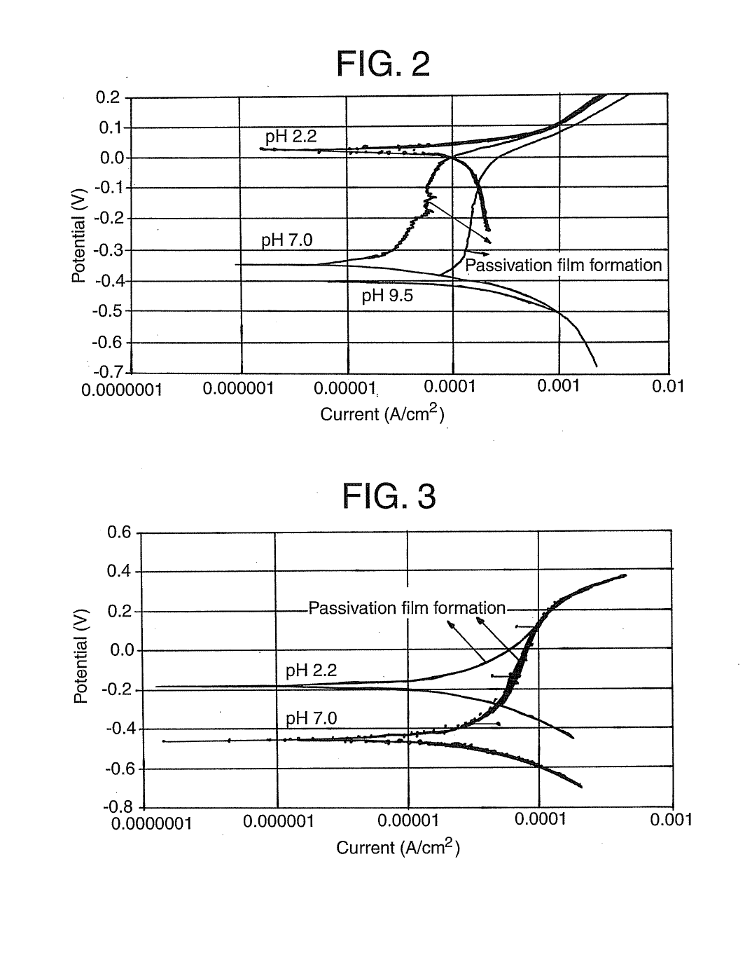

Graphs plotting current (A/cm², or “i”) versus potential (V) were obtained for each composition during abrasion at an acidic pH, i.e., pH=2.2 and 3.6, a neutral pH, i.e., pH=7.0, and at an alkaline pH, i.e., pH=9.5. The i-V curves for Compositions 1A-1C are shown in FIGS. 2-4, respectively. The potential is relative to the mercury-mercurous sulfate electrode (MSE) scale, which is +0.615 V relative to the standard hydrogen electrode (SHE) scale. While not wishing to be bound by any particular theory, passivating behavior, i.e., a slight increase in current despite a wide range of increase in potential, is believed to be the result of the formation of a hard, protective film layer of RuO₂. The i-V curves for each composition were analyzed for passivating behavior indicating the formation of the protective film of RuO₂. The results are summarized in Table 1.

TABLE 1

| Polishing | Oxidizing | pH | | | |
|---|---|---|---|---|---|
| Composition | Agent | 2.2 | 3.6 | 7.0 | 9.5 |
| 1A | I₂•(C₃H₂O₄)₃ | No passivating | — | Passivating | Passivating |
| (comparative) | | behavior | | behavior | behavior |
| | | observed | | observed | observed |
| 1B | NaNO₂ | Passivating | — | Passivating | — |
| (comparative) | | behavior | | behavior | |
| | | observed | | observed | |
| 1C | NaBO₃•H₂O | Passivating | Passivating | Passivating | No passivating |
| (inventive) | | behavior | behavior | behavior | behavior |
| | | observed | observed | observed | observed |

As is shown in FIG. 2 and indicated in Table 1, Composition 1A exhibits passivating behavior at pH 7.0 and 9.5. While passivating behavior was not observed at pH 2.2, the open-circuit potential of ruthenium is very high at this low pH, i.e., more than 0.65 V higher than the corresponding copper potential at this pH, which will result in galvanic incompatibility between ruthenium and copper.

As is shown in FIG. 3 and indicated in Table 1, Composition 1B exhibits passivating behavior at both pH 2.2 and at pH 7.0

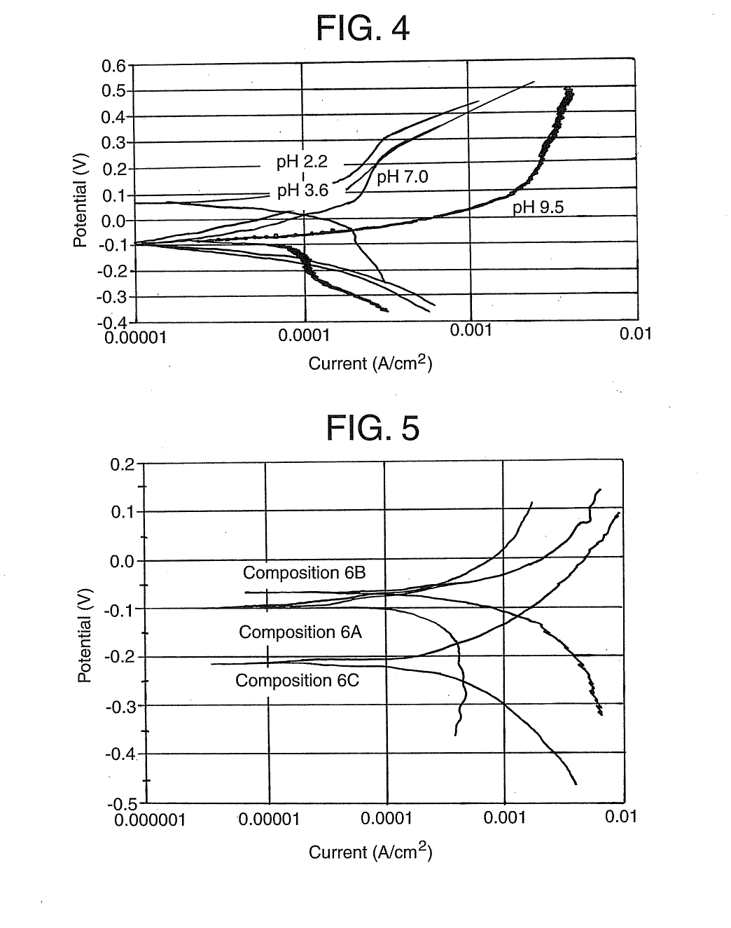

However, as shown in FIG. 4 and indicated in Table 1, Composition 1C, which uses a perborate oxidizing agent, does not exhibit passivating behavior at alkaline pH. The open-circuit potential at pH=9.5 is −0.1 V relative to the MSE, i.e., 0.515 V relative to the SHE scale. According to FIG. 1, RuO₂ is expected to be formed at this potential at pH=9.5. The lack of passivating behavior demonstrates that the use of a perborate oxidizing agent modifies the protective nature of the RuO₂ film.

### Example 2

This example demonstrates the effect of an ammonia derivative on CMP compositions utilized for ruthenium polishing.

Chemical-mechanical polishing compositions were prepared using varied amounts of ammonium acetate (Polishing Compositions 2A-2D). Each composition was electrochemically tested to determine the open-circuit potential for both copper and ruthenium. The electrochemical test procedure was carried out as described above, except that to test the open-circuit potential of copper, a copper working electrode was used in place of a ruthenium working electrode. The potential is relative to the mercury-mercurous sulfate electrode (MSE) scale, which is +0.615 V relative to the standard hydrogen electrode (SHE). The open-circuit potentials of the polishing compositions were measured with and without abrasion.

Each composition included 4 wt. % colloidal silica as an abrasive and 1 wt. % sodium perborate monohydrate at a pH of about 9.5. Each composition also included varied amounts of benzotriazole (BTA) and ammonium acetate, as indicated in Table 2.

TABLE 2

| | | | | | Open-Circuit | |
|---|---|---|---|---|---|---|
| | | Amount of | Open-Circuit | | Potential | |
| | Amount | Ammonium | Potential With | | Without | |
| Polishing | of BTA | Acetate | Abrasion (mV) | | Abrasion (mV) | |
| Composition | (wt. %) | (wt. %) | Ru | Cu | Ru | Cu |
| 2A | 0 | 0 | −133 | −341 | −158 | −246 |
| 2B | 0.1 | 0 | −120 | −353 | −131 | −264 |
| 2C | 0.1 | 0.5 | −192 | −314 | −233 | −244 |
| 2D | 0 | 0.5 | −234 | −316 | −260 | −256 |

These results demonstrate that while the ammonia derivative does not have much effect on the open-circuit potential of copper (compare, for example, the open-circuit potential of Cu in Composition 2A with that of Composition 2D), both with and without abrasion, the ammonia derivative can reduce the open-circuit potential of ruthenium by about 100 mV (compare, for example, the open-circuit potential of Ru in Composition 2A with that of Composition 2D). The addition of the ammonia derivative results in an open-circuit potential of ruthenium that is closer to that of copper (see, for example, Composition 2D), thereby reducing the risk of galvanic incompatibility between ruthenium and copper during CMP applications.

### Example 3

This example demonstrates the effect of an ammonia derivative on CMP compositions utilized for ruthenium polishing.

Chemical-mechanical polishing compositions were prepared including various ammonia derivatives (Polishing Compositions 3A-3I). Each composition was electrochemically tested to determine the open-circuit potential for both copper and ruthenium. The electrochemical test procedure was carried out as described above, except that to test the open-circuit potential of copper, a copper working electrode was used in place of a ruthenium working electrode. The open-circuit potentials of the polishing compositions were measured with and without abrasion.

Each composition included 4 wt. % colloidal silica as an abrasive and 0.25 wt. % sodium perborate monohydrate at a pH of about 9.5, adjusted with nitric acid as necessary. Each composition included a different ammonia derivative, as indicated in Table 3.

TABLE 3

| | | | Open-Circuit |
|---|---|---|---|
| | | Open-Circuit | Potential of |
| | | Potential of Ru | Ru Without |
| Polishing | | With Abrasion | Abrasion |
| Composition | Ammonia Derivative | (mV) | (mV) |
| 3A | None | −90 | −99 |
| 3B | NH₃ | −274 | −282 |
| 3C | H₂NCH₃ | −212 | −229 |
| 3D | HN(CH₃)₂ | −121 | −131 |
| 3E | N(CH₃)₃ | −104 | −108 |
| 3F | H₂NOH | −592 | −578 |
| 3G | H₂NCH₂CH₂OH | −284 | −247 |
| 3H | HN(CH₂CH₂OH)₂ | −226 | −194 |
| 3I | N⁺(CH₂CH₂CH₂CH₃)₄OH⁻ | −91 | −91 |

These results demonstrate the effectiveness of hydroxylamines and methylamines at reducing the open-circuit potential of ruthenium. These results further demonstrate that hydroxylamine is particularly effective at reducing the open-circuit potential of ruthenium. Without wishing to be bound by any particular theory, it is believed that because hydroxylamine is a reducing agent, it can react with the perborate oxidizing agent, thereby reducing the effective concentration of the oxidizing agent. Accordingly, ruthenium exhibits a lower open-circuit potential when hydroxylamine is present in the polishing composition.

### Example 4

This example demonstrates the effect of the concentrations of the oxidizing agent and the abrasive on the removal rates of ruthenium, tantalum, and TEOS (tetraethyl orthosilicate) during polishing.

Chemical-mechanical polishing compositions were prepared including various concentrations of oxidizing agent and abrasive (Polishing Compositions 4A-4G). Polishing Compositions 4A-4F contained colloidal silica as an abrasive, sodium perborate as an oxidizing agent, and 0.5 wt. % ammonia acetate at a pH of 9.85 adjusted with NH₄OH as necessary. For comparison, Composition 4G contained colloidal silica, 0.5 wt. % potassium acetate, and hydrogen peroxide at pH 10 adjusted with KOH. The amount of abrasive and oxidizing agent in each composition is indicated in Table 4.

Polishing was conducted using a Logitech polisher using an IC1000 polishing pad. The Logitech process was set with approximately 14 kPa (2.1 psi) down force, a platen speed of 100 rpm, a carrier speed of 102 rpm, and a slurry flow rate of 150 mL/min.

TABLE 4

| | Amount of | Amount of | | | TEOS |
|---|---|---|---|---|---|
| Polishing | Abrasive | Oxidizing | Ru Removal | Ta Removal | Removal Rate |
| Composition | (wt. %) | Agent (wt. %) | Rate (Å/min) | Rate (Å/min) | (Å/min) |
| 4A | 4 | 0.25 | 71 | 349 | 224 |
| 4B | 8 | 0.25 | 97 | 546 | 631 |
| 4C | 12 | 0.25 | 154 | 933 | 1265 |
| 4D | 20 | 0.25 | 171 | — | — |
| 4E | 4 | 1 | 166 | 645 | 373 |
| 4F | 12 | 1 | — | 980 | 1265 |
| 4G | 12 | 1 | 18 | 806 | 1152 |
| (Comparative) | | | | | |

These results demonstrate that perborate is an effective oxidizing agent for both ruthenium and tantalum polishing. The removal rate of both ruthenium and tantalum increases with increasing concentration of perborate ions (compare, for example, Compositions 4A and 4E). These results further demonstrate that the amount of abrasive has a substantial impact on the removal rate of ruthenium, tantalum, and TEOS (compare, for example, Compositions 4A and 4C). An increase in the concentration of abrasive increases the removal rate of all three layers. In comparison, Polishing Composition 4G, which contained hydrogen peroxide as an oxidizing agent, shows a relatively low ruthenium removal rate, i.e., about 4-10 times lower than that of perborate (compare, for example, Compositions 4C and 4G). The perborate and hydrogen peroxide oxidizing agents produce comparable removal rates of tantalum (compare, for example, Compositions 4C and 4G).

### Example 5

This example demonstrates the effectiveness of percarbonate as an oxidizing agent for ruthenium, tantalum, and TEOS polishing applications.

Chemical-mechanical polishing compositions were prepared including either 1 wt. % hydrogen peroxide or 1 wt. % percarbonate as an oxidizing agent (Polishing Compositions 5A-5B). Each composition included 12 wt. % colloidal silica as an abrasive and 0.1 wt. % BTA. Composition 5A also included 0.5 wt. % potassium acetate.

Polishing was conducted using a Logitech polisher using an IC1000 polishing pad. The Logitech process was set with approximately 19 kPa (2.8 psi) down force, a platen speed of 90 rpm, a carrier speed of 93 rpm, and a slurry flow rate of 180 mL/min. The removal rates for each polishing composition are summarized in Table 5.

TABLE 5

| | | | | | TEOS |
|---|---|---|---|---|---|
| | | | Ru | Ta | Remov- |
| Polishing | | | Removal | Removal | al |
| Compo- | Oxidizing | pH | Rate | Rate | Rate |
| sition | Agent | Adjustment | (Å/min) | (Å/min) | (Å/min) |
| 5A | Hydrogen | pH 10 with | 18 | 806 | 1152 |
| | Peroxide | KOH | | | |
| 5B | Sodium | pH 10 with | 51 | 1214 | 2136 |
| | Percarbonate | ammonia | | | |

These results demonstrate that a polishing composition utilizing percarbonate as an oxidizing agent produces a removal rate of ruthenium that is about 3 times higher than that of a polishing composition utilizing hydrogen peroxide as an oxidizing agent with the same concentrations of abrasive and oxidizing agent.

### Example 6

This example demonstrates the effect of a CMP composition comprising hydrogen peroxide in combination with a source of borate anions on ruthenium polishing.

Chemical-mechanical polishing compositions were prepared with three different oxidizing agents (Polishing Compositions 6A-6C). Each composition included a different combination of an oxidizing agent, 4 wt. % colloidal silica as an abrasive and, optionally, a source of borate anions, as indicated in Table 6.

TABLE 6

| | | | | Amount of | | |
|---|---|---|---|---|---|---|
| | | Amount of | | Source of | | |
| | | Oxidizing | Source of | Borate | | |
| Polishing | Oxidizing | Agent(s) | Borate | Anions | | pH |
| Composition | Agent(s) | (wt. %) | Anions | (wt. %) | pH | Adjustment? |
| 6A | Sodium | 0.25 | — | — | 9.85 | No |
| | Perborate | | | | | |
| | Monohydrate | | | | | |
| | (NaBO₃•H₂O) | | | | | |
| 6B | Hydrogen | 1 | Potassium | 0.25 | 9.85 | KOH |
| | Peroxide | | Tetraborate | | | |
| | | | Tetrahydrate | | | |
| 6C | Hydrogen | 1 | Potassium | 0.5 | 9.85 | Ammonia |
| | Peroxide | | Tetraborate | | | |
| | | | Tetrahydrate | | | |

Each composition was electrochemically tested to determine whether it was suitable for ruthenium polishing. The electrochemical test procedure was carried out as described above.

i-V curves were obtained for each composition during abrasion. The i-V curves for Compositions 6A-6C are shown in FIG. 5. The potential is relative to the mercury-mercurous sulfate electrode (MSE) scale, which is +0.615 V relative to the standard hydrogen electrode (SHE).

These results demonstrate that the combination of a source of borate anions, e.g., tetraborate, and an oxidizing agent comprising hydrogen peroxide functions similarly to perborate in ruthenium and tantalum polishing. CMP compositions such as Compositions 6A and 6B prevent the passivating behavior that is believed to be the result of the formation of a hard, protective film layer of RuO₂. Moreover, as illustrated by Composition 6C, the addition of ammonia to a polishing composition comprising a source of borate anions lowers the open-circuit potential of ruthenium more than 100 mV, reducing the risk of galvanic incompatibility between copper and ruthenium.

### Example 7

This example demonstrates the effect of an oxidizing agent in combination with a source of borate anions on tantalum and TEOS removal rates during polishing.

Chemical-mechanical polishing compositions were prepared including sodium perborate monohydrate (Compositions 7A, 7C, and 7E) or an equimolar amount of a combination of hydrogen peroxide and potassium tetraborate tetrahydrate (Compositions 7B, 7D, and 7F). Each composition included colloidal silica as an abrasive and 0.5 wt. % ammonium acetate, and was adjusted to a pH of 9.85 with ammonia.

Polishing was conducted using a Logitech polisher using a IC1000 polishing pad. The Logitech process was set with approximately 21 kPa (3.1 psi) down force, a platen speed of 90 rpm, a carrier speed of 93 rpm, and a slurry flow rate of 180 mL/min. The removal rates for each polishing composition are summarized in Table 7.

TABLE 7

| | | | | Ta | TEOS |
|---|---|---|---|---|---|
| Polishing | Amount of | | Source of | Removal | Removal |
| Compo- | Abrasive | Oxidizing | Borate | Rate | Rate |
| sition | (wt. %) | Agent(s) | Anions | (Å/min) | (Å/min) |
| 7A | 4 | Perborate | — | 349 | 224 |
| 7B | 4 | H₂O₂ | Tetraborate | 393 | 302 |
| 7C | 8 | Perborate | — | 546 | 631 |
| 7D | 8 | H₂O₂ | Tetraborate | 615 | 653 |
| 7E | 12 | Perborate | — | 933 | 1265 |
| 7F | 12 | H₂O₂ | Tetraborate | 906 | 1210 |

These results demonstrate that polishing compositions comprising a combination of a hydrogen peroxide oxidizing agent and a source of borate anions, e.g., tetraborate, produce comparable tantalum and TEOS removal rates to polishing compositions comprising a perborate oxidizing agent.

### Example 8

This example demonstrates the effect of an oxidizing agent, e.g., perborate, or, alternatively, an oxidizing agent in combination with a source of borate anions, e.g., hydrogen peroxide in combination with tetraborate, on ruthenium and tantalum removal rates during polishing. This example further demonstrates the ability of perborate or a hydrogen peroxide and tetraborate combination to clear ruthenium pattern wafers.

Chemical-mechanical polishing compositions were prepared including sodium perborate monohydrate (Compositions 8B and 8C) or a combination of hydrogen peroxide and ammonium biborate tetrahydrate (B₄O₇²⁻) (Compositions 8D and 8E), as indicated in Table 8A. Compositions 8B-8E included 8 wt. % colloidal silica as an abrasive, 0.5 wt. % tartaric acid and 500 ppm BTA, and were adjusted to pH 9.85 with ammonia. For comparison, as also indicated in Table 8A, Composition 8A included only 1 wt. % hydrogen peroxide as the oxidizing agent, but contained 12 wt. % colloidal silica as an abrasive at a pH of 9.5.

Ruthenium pattern wafers were cut into 4.2×5.1 cm (1.65×2 inch) squares, with each square containing a full die, from 300 mm pattern wafers. The Ru pattern wafers contained 25 Å Ru deposited on the top of 25 A TaN. The copper in the Ru pattern wafers was chemically etched out.

Polishing was conducted using a Logitech polisher and a IC1000 polishing pad. The Logitech process was set with approximately 19 kPa (2.8 psi) down force, a platen speed of 90 rpm, a carrier speed of 93 rpm, and a slurry flow rate of 180 mL/min. The removal rates for each polishing composition are summarized in Table 8B.

TABLE 8A

| | | | | Amount of |
|---|---|---|---|---|
| | | Amount of | | Source of |
| Polishing | Oxidizing | Oxidizing Agent | Source of Borate | Borate Anions |
| Composition | Agent | (wt. %) | Anions | (wt. %) |
| 8A | H₂O₂ | 1 | — | — |
| (Comparative) | | | | |
| 8B | Perborate | 0.25 | — | — |
| 8C | Perborate | 1 | — | — |
| 8D | H₂O₂ | 1 | Ammonium biborate | 0.25 |
| | | | tetrahydrate (B₄O₇²⁻) | |
| 8E | H₂O₂ | 1 | Ammonium biborate | 1 |
| | | | tetrahydrate (B₄O₇²⁻) | |

TABLE 8B

| Polishing | | Ta Removal Rate | TEOS Removal Rate |
|---|---|---|---|
| Composition | Ru Pattern | (Å/min) | (Å/min) |
| 8A (Comparative) | Not | 967 | 1002 |
| | cleared | | |
| 8B | Cleared | 776 | 930 |
| 8C | Cleared | 1040 | 1124 |
| 8D | Cleared | 1135 | 1059 |
| 8E | Cleared | 1029 | 747 |

These results demonstrate that chemical-mechanical polishing compositions including an oxidizing agent comprising perborate, or an oxidizing agent comprising a peroxide, e.g., hydrogen peroxide, in combination with a source of borate anions, e.g., ammonium biborate tetrahydrate, effectively clear ruthenium pattern wafers and also effectively remove Ta and TEOS layers during chemical-mechanical polishing. A chemical-mechanical polishing composition utilizing hydrogen peroxide alone, in contrast, is not able to effectively clear ruthenium pattern wafers.

### Example 9

This example demonstrates the effect of colloidal silica abrasive in combination with an oxidizing agent and a source of borate anions on the removal rates of ruthenium, tantalum, and TEOS during chemical-mechanical polishing. This example further demonstrates the ability colloidal silica in combination with an oxidizing agent and a source of borate anions to clear ruthenium pattern wafers.

Ruthenium pattern wafers were cut into 4.2×5.1 cm (1.65×2 inch) squares, with each square containing a full die, from 300 mm pattern wafers. The Ru pattern wafers contained 25 Å Ru deposited on the top of 25 A TaN. The copper in the Ru pattern wafers was chemically etched out.

Polishing was conducted using a Logitech polisher and a IC1000 polishing pad. The Logitech process was set with approximately 19 kPa (2.8 psi) down force, a platen speed of 90 rpm, a carrier speed of 93 rpm, and a slurry flow rate of 180 mL/min. The removal rates for each polishing composition are summarized in Table 9.

Chemical-mechanical polishing compositions were prepared including varying amounts of abrasive and a source of borate anions, as indicated in Table 9. Each polishing composition included 1 wt. % hydrogen peroxide, 0.5 wt. % ammonium acetate and 500 ppm BTA, and was adjusted to pH 9.25 or 9.85, as indicated in Table 9, with NH₄OH. The source of borate anions was ammonium biborate tetrahydrate.

TABLE 9

| | | | Amount | | | | |
|---|---|---|---|---|---|---|---|
| | | Amount | of Source | | Ru | Ta | TEOS |
| | | of | of Borate | Ru | Removal | Removal | Removal |
| Polishing | | Abrasive | Anions | Pattern | Rate | Rate | Rate |
| Composition | pH | (wt. %) | (wt. %) | Cleared? | (Å/min) | (Å/min) | (Å/min) |
| 9A | 9.85 | 1 | 0.1 | Cleared | 39 | 161 | 92 |
| 9B | 9.85 | 4 | 0.1 | Cleared | 82 | 370 | 588 |
| 9C | 9.85 | 7 | 0.1 | Cleared | 30 | 283 | 654 |
| 9D | 9.85 | 1 | 0.3 | Cleared | 68 | 206 | 132 |
| 9E | 9.85 | 4 | 0.3 | Cleared | 111 | 405 | 459 |
| 9F | 9.85 | 7 | 0.3 | Cleared | 139 | 607 | 1087 |
| 9G | 9.25 | 4 | 0.3 | Cleared | 71 | 485 | 506 |
| 9H | 9.25 | 7 | 0.3 | Cleared | 109 | 902 | 1090 |
| 9I | 9.85 | 1 | 0.5 | Cleared | 95 | 363 | 196 |
| 9J | 9.85 | 4 | 0.5 | Cleared | 137 | 514 | 710 |
| 9K | 9.85 | 7 | 0.5 | Cleared | 139 | 553 | 743 |

These results demonstrate that an increase in the concentration of abrasive and/or the source of borate anions increases the removal rates of Ru, Ta, and TEOS. A lower pH, i.e., 9.25 as opposed to 9.85, will slightly lower the ruthenium removal rate but will not appreciably affect the Ta or TEOS removal rates. In all cases, the Ru pattern wafers were cleared.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition comprising:
(a) an abrasive,
(b) an aqueous carrier,
(c) an oxidizing agent having a standard reduction potential of greater than 0.7 V and less than 1.3 V relative to a standard hydrogen electrode, and
(d) optionally a source of borate anions, with the proviso that when the oxidizing agent comprises a peroxide other than perborate, percarbonate, or perphosphate, the chemical-mechanical polishing composition further comprises a source of borate anions,
wherein the pH of the chemical-mechanical polishing composition is between about 7 and about 12.

2. The chemical-mechanical polishing composition of claim 1, wherein the oxidizing agent oxidizes ruthenium to the +3 oxidation state.

3. The chemical-mechanical polishing composition of claim 1, wherein the oxidizing agent oxidizes ruthenium to the +4 oxidation state.

4. The chemical-mechanical polishing composition of claim 1, wherein the oxidizing agent comprises perborate, percarbonate, perphosphate, hydrogen peroxide, or combinations thereof.

5. The chemical-mechanical polishing composition of claim 4, further comprising a source of borate anions.

6. The chemical-mechanical polishing composition of claim 1, wherein the oxidizing agent is present in the chemical-mechanical polishing composition at a concentration of about 0.05 wt. % to about 10 wt. %.

7. The chemical-mechanical polishing composition of claim 1, further comprising an ammonia derivative selected from the group consisting of ammonium-containing compounds, hydroxylamines, methylamines, and combinations thereof.

8. The chemical-mechanical polishing composition of claim 7, wherein the ammonia derivative is present in the chemical-mechanical polishing composition at a concentration of about 0.01 wt. % to about 2 wt. %.

9. The chemical-mechanical polishing composition of claim 1, wherein the abrasive is a metal oxide selected from the group consisting of alumina, silica, ceria, zirconia, titania, germania, and combinations thereof.

10. The chemical-mechanical polishing composition of claim 9, wherein the metal oxide abrasive is silica.

11. The chemical-mechanical polishing composition of claim 1, wherein the oxidizing agent comprises perborate.

12. A method of polishing a substrate comprising:
(i) providing a substrate;
(ii) providing a chemical-mechanical polishing composition comprising:
(a) an abrasive,
(b) an aqueous carrier,
(c) an oxidizing agent having a standard reduction potential of greater than 0.7 V and less than 1.3 V relative to a standard hydrogen electrode, and
(d) optionally a source of borate anions, with the proviso that when the oxidizing agent comprises a peroxide other than perborate, percarbonate, or perphosphate, the chemical-mechanical polishing composition further comprises a source of borate anions,
wherein the pH of the chemical-mechanical polishing composition is between about 7 and about 12;
(iii) contacting the substrate with a polishing pad and the chemical-mechanical polishing composition; and
(iv) moving the polishing pad and the chemical-mechanical polishing composition relative to the substrate to abrade at least a portion of the surface of the substrate to polish the substrate.

13. The method of claim 12, wherein the substrate comprises ruthenium, tantalum, copper, TEOS, or a combination thereof, and at least a portion of the substrate is abraded to polish the substrate.

14. The method of claim 13, wherein the substrate comprises ruthenium, and at least a portion of the ruthenium is abraded to polish the substrate.

15. The method of claim 12, wherein the oxidizing agent oxidizes ruthenium to the +3 oxidation state.

16. The method of claim 12, wherein the oxidizing agent oxidizes ruthenium to the +4 oxidation state.

17. The method of claim 12, wherein the oxidizing agent comprises perborate, percarbonate, perphosphate, hydrogen peroxide, or combinations thereof.

18. The method of claim 12, wherein the oxidizing agent is present in the chemical-mechanical polishing composition at a concentration of about 0.05 wt. % to about 10 wt. %.

19. The method of claim 17, wherein the oxidizing agent is selected from the group consisting of potassium perborate, sodium perborate monohydrate, and combinations thereof.

20. The method of claim 17, wherein the oxidizing agent is hydrogen peroxide and wherein the chemical-mechanical polishing composition further comprises a source of borate anions selected from the group consisting of potassium tetraborate tetrahydrate, ammonium biborate tetrahydrate, and combinations thereof.

21. The method of claim 12, wherein the chemical-mechanical polishing composition further comprises an ammonia derivative selected from the group consisting of ammonium-containing compounds, hydroxylamines, methylamines, and combinations thereof.

22. The method of claim 21, wherein the ammonia derivative is present in the chemical-mechanical polishing composition at a concentration of about 0.01 wt. % to about 2 wt. %.

23. The method of claim 21, wherein the ammonia derivative reduces the open-circuit potential of ruthenium by about 0.1 V to about 0.3 V relative to a standard hydrogen electrode.

24. The method of claim 12, wherein the abrasive is a metal oxide selected from the group consisting of alumina, silica, ceria, zirconia, titania, germania, and combinations thereof.

25. The method of claim 24, wherein the metal oxide abrasive is silica.
